(19) United States
(12) Patent Application Publication
(10) Pub. No.: US 2026/0331942 A1
(43) Pub. Date: Oct. 22, 2026

(54) Temperature-Based Battery-Charging-Profile Architectures and Applications Thereof

(71) Applicant: Google LLC, Mountain View, CA (US)

(72) Inventors: James Robert Lim, Mountain View, CA (US); William Alan Saperstein, San Carlos, CA (US); Nachiket Mukund Kharalkar, Cupertino, CA (US)

(73) Assignee: Google LLC, Mountain View, CA (US)

(21) Appl. No.: 18/997,156

(22) PCT Filed: Jun. 30, 2023
(86) PCT No.: PCT/US2023/069547

§ 371 Date: Jan. 20, 2025

Related U.S. Application Data
(60) Provisional application No. 63/374,188, filed on Aug. 31, 2022.

(51) Int. Cl. H02J 7/90; H01M 10/44; H01M 10/46; H02J 7/80

(52) U.S. Cl. CPC H02J 7/977; H01M 10/443; H01M 10/46; H02J 7/80

(57) ABSTRACT

The present document describes techniques associated with temperature-based battery-charging-profile architectures and applications thereof. Although advances in battery chemistries may enable batteries to be charged at temperatures that are higher or lower than the limits of conventional-battery chemistries (e.g., 0 °C to 60 °C), conventional hardware is generally restricted (e.g., hardcoded) to those limits. However, the temperature-based battery-charging-profile architectures and applications thereof, as described herein, provide a low-cost solution for conventional battery-charging hardware to be able to charge batteries with battery chemistries having expanded charging limits. The techniques described herein enable charging of batteries at temperatures that are outside of the standard JEITA mask by utilizing a switching mechanism operated by a controller that switches, based on the battery temperature, to a different charge profile with a reduced charge rate at a reduced voltage and/or current without affecting the JEITA mask.

### RELATED APPLICATIONS

This application claims priority to U.S. Provisional Application Ser. No. 63/374,188, filed Aug. 31, 2022, the disclosure of which is incorporated by reference herein in its entirety.

### BACKGROUND

Many conventional industry-standard lithium-ion (Li-ion) batteries have a charging profile of zero degrees Celsius (°C) to 60 °C, which prohibits charging below 0 °C and above 60 °C. However, outdoor battery-powered devices may experience internal battery temperatures that are less than 0 °C, particularly in cold environments such as Canada or Alaska in the United States. Product operating temperatures, specifically for discharge of the battery, may be from −20 °C to 40 °C, for example. For battery-powered “wired” devices, which receive trickle charge within 0 °C to 60 °C, the battery is unable to trickle charge below 0 °C, even though the battery may continue to discharge. With the impact of battery performance at low temperatures in addition to the battery being unable to trickle charge, the battery may be depleted, leading to device shutdown and a diminished user experience.

Recent developments in battery chemistry enable charging down to −10 °C However, conventional hardware associated with battery charging is limited because it is designed for the 0 °C to 60 °C charging profile (set by Japan Electronics and Information Technology Industries Association (JEITA)). In particular, the charging profile is hardcoded, usually in the charger chip. Conventional charger chips enable developers to set the charge current within the charging profile (also referred to as a JEITA mask) but at the extremes (e.g., 0 °C and 60 °C) the JEITA mask causes charging to shut down. Shifting the hardware to enable charging down to −10 °C results in a charging profile of −10 °C to 50 °C, decreasing the high end of the charging profile and consequently preventing charging above 50 °C instead of the industry standard of 60 °C. Further, settings associated with midrange temperatures (e.g., 15 °C, 30 °C, 45 °C) may also be affected by the shift.

### SUMMARY

The present document describes techniques associated with temperature-based battery-charging-profile architectures and applications thereof. Although advances in battery chemistries may enable batteries to be charged at temperatures that are higher or lower than the limits of conventional-battery chemistries (e.g., 0 °C to 60 °C), conventional hardware is generally restricted (e.g., hardcoded) to those limits. However, the temperature-based battery-charging-profile architectures and applications thereof, as described herein, provide a low-cost solution for conventional battery-charging hardware to be able to charge batteries with battery chemistries having expanded charging limits. The techniques described herein enable charging of batteries at temperatures that are outside of the standard JEITA mask by utilizing a switching mechanism operated by a controller that switches, based on the battery temperature, to a different charge profile with a reduced charge rate at a reduced voltage and/or current without affecting the JEITA mask.

This summary is provided to introduce simplified concepts of temperature-based battery-charging-profile architectures and applications thereof, which are further described below in the Detailed Description.

### BRIEF DESCRIPTION OF DRAWINGS

The details of one or more aspects of temperature-based battery-charging-profile architectures and applications thereof are described in this document with reference to the following drawings. The same numbers are used throughout the drawings to reference like features and components:

FIG. 1 illustrates an example network environment in which aspects of temperature-based battery-charging-profile architectures and applications thereof can be implemented;

FIG. 2 illustrates an example implementation of an electronic device from FIG. 1 in more detail;

FIG. 3 illustrates an example circuit diagram for implementing temperature-based battery-charging-profile architectures and applications thereof;

FIG. 4 depicts a method for applying temperature-based battery-charging profiles in an electronic device;

FIG. 5 depicts a method for applying temperature-based battery-charging profiles in an electronic device for high and low temperatures;

FIG. 6 depicts another example method for applying temperature-based battery-charging profiles in an electronic device for low temperatures;

FIG. 7 illustrates an example environment in which a home area network, as described with reference to FIG. 1, and aspects of temperature-based battery-charging-profile architectures and applications thereof can be implemented;

FIG. 8 illustrates an example electronic device that can be implemented as any of the electronic devices in a home area network in accordance with one or more aspects of temperature-based battery-charging-profile architectures and applications thereof as described herein; and

FIG. 9 illustrates an example system that includes an example device, which can be implemented as any of the electronic devices that implement aspects of temperature-based battery-charging-profile architectures and applications thereof as described with reference to the previous FIGS. 1 to 8.

### DETAILED DESCRIPTION

### Overview

The present document describes techniques and apparatuses associated with temperature-based battery-charging-profile architectures and applications thereof. These techniques implement a hardware solution that enables a battery, which includes chemistry capable of being charged at battery temperatures outside of standard temperature limits set by conventional hardware (e.g., charger chips), to be safely charged at those temperatures without causing damage to the battery.

Consider an example in which a video-recording doorbell having both a battery and line power is attached to an exterior surface of a house. The doorbell shares transistor power with a chime located inside the house. When the doorbell button is pressed, the transistor power is switched over to the chime to notify the homeowner and the doorbell switches over to battery power to continue operations (e.g., recording video, capturing images, face detection, facial recognition). Typically, the line power is used to charge (e.g., trickle charge) the battery to maintain a charge so the battery is usable at any given moment when the chime is activated. However, during extremely cold weather (e.g., −20 °C), conventional batteries can be discharged to operate the device but cannot be charged. This is due to safety measures implemented (e.g., hardcoded) in the device hardware to protect the battery chemistry. Accordingly, the doorbell may continue to record video, without being charged, and then turn off when the battery is depleted, resulting in user frustration and a poor user experience. Using the techniques described herein, however, the battery can be charged at temperatures outside of the standards defined by the JEITA mask without having to incorporate expensive hardware components and without adversely affecting the JEITA mask, and without damaging the battery.

Consider another example in which a user is skiing in snow and cold weather and notices that their smartphone, camera, or global-positioning-satellite (GPS) device needs to be charged. The user may connect their device to a power bank, their vehicle (which is cold due to being parked in the cold weather for hours), or an external outlet at the ski lodge. Charging the device in such circumstances may be prevented due to protections in place by the hardware of the device, which is configured to the limits of conventional battery chemistry. However, current battery chemistries may be able to be charged at such low temperatures even though the hardware is still configured for the previous limits. Using the techniques described herein, the device can, based on the battery temperature, switch to a different charge profile that enables charging at such low temperatures. In this way, the user does not need to first warm up their device (and the device's battery) to charge the device. Rather, the user can stay outside while charging the device (e.g., the user may be on the mountain far from the lodge and their vehicle but may use the power bank to charge their device in the cold weather).

The techniques described herein enable charging of batteries having battery chemistries capable of being charged at temperatures outside of present standards (e.g., JEITA mask) but which have hardware limited to the present standards. These techniques switch to a different charge profile without adversely affecting the JEITA mask set by the hardware. In some aspects, a switching mechanism connected to a voltage divider network is used by a controller to switch to a different set of resistors based on the temperature of the battery. The different set of resistors corresponds to a different charge profile having a reduced charge rate at a reduced voltage and/or reduced current for charging the battery at certain extreme temperatures.

While features and concepts of the described techniques for temperature-based battery-charging-profile architectures and applications thereof can be implemented in any number of different environments, aspects are described in the context of the following examples.

### Example Systems and Apparatuses

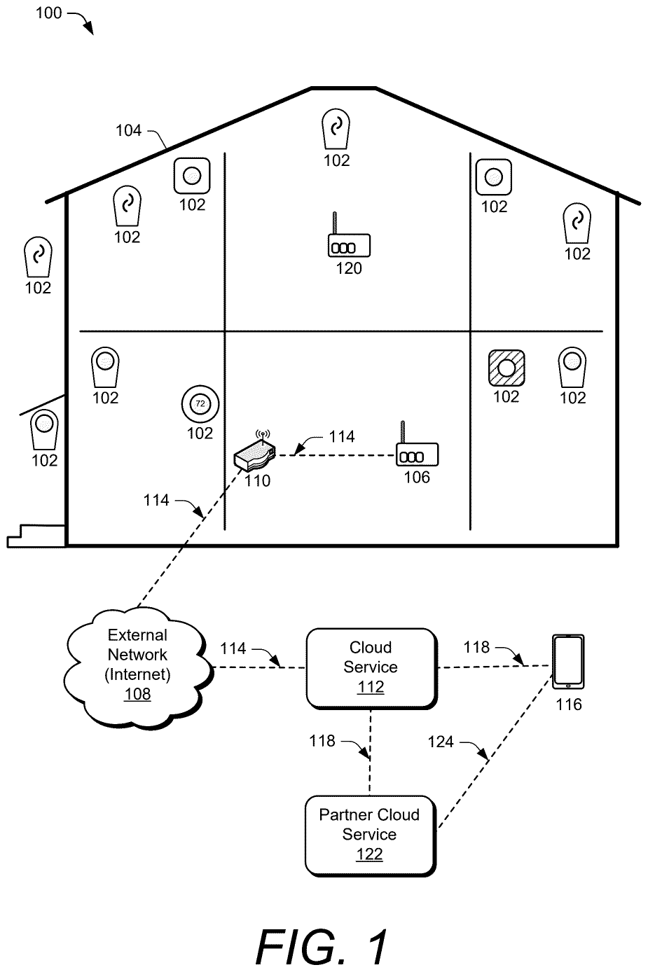

FIG. 1 illustrates an example network environment 100 in which aspects of temperature-based battery-charging-profile architectures and applications thereof can be implemented. The network environment 100 includes a home area network (HAN). The HAN includes electronic devices (e.g., wireless network devices 102) that are disposed about a structure 104, such as a house, and are connected by one or more wireless and/or wired network technologies, as described below. The HAN includes a border router 106 that connects the HAN to an external network 108, such as the Internet, through a home router or access point 110.

To provide user access to functions implemented using the wireless network devices in the HAN, a cloud service 112 connects to the HAN via a border router 106, via a secure tunnel 114 through the external network 108 and the access point 110. The cloud service 112 facilitates communication between the HAN and internet clients 116, such as apps on mobile devices, using a web-based application programming interface (API) 118. The cloud service 112 also manages a home graph that describes connections and relationships between the wireless network devices 102, elements of the structure 104, and users. The cloud service 112 hosts controllers which orchestrate and arbitrate home automation experiences, as described in greater detail below.

The HAN may include one or more wireless network devices 102 that function as a hub 120. The hub 120 may be a general-purpose home automation hub, or an application-specific hub, such as a security hub, an energy management hub, a heating, ventilation, and air conditioning (HVAC) hub, and so forth. The functionality of a hub 120 may also be integrated into any wireless network device 102, such as a smart thermostat device or the border router 106. In addition to hosting controllers on the cloud service 112, controllers can be hosted on any hub 120 in the structure 104, such as the border router 106. A controller hosted on the cloud service 112 can be moved dynamically to the hub 120 in the structure 104, such as moving an HVAC zone controller to a newly installed smart thermostat.

Hosting functionality on the hub 120 in the structure 104 can improve reliability when the user's internet connection is unreliable, can reduce latency of operations that would normally have to connect to the cloud service 112, and can satisfy system and regulatory constraints around local access between wireless network devices 102.

The wireless network devices 102 in the HAN may be from a single manufacturer that provides the cloud service 112 as well, or the HAN may include wireless network devices 102 from partners. These partners may also provide partner cloud services 122 that provide services related to their wireless network devices 102 through a partner Web API 124. The partner cloud service 122 may optionally or additionally provide services to internet clients 116 via the web-based API 118, the cloud service 112, and the secure tunnel 114.

The network environment 100 can be implemented on a variety of hosts, such as battery-powered microcontroller-based devices, line-powered devices, and servers that host cloud services. Protocols operating in the wireless network devices 102 and the cloud service 112 provide a number of services that support operations of home automation experiences in a distributed computing environment (e.g., network environment 100). These services include, but are not limited to, real-time distributed data management and subscriptions, command-and-response control, real-time event notification, historical data logging and preservation, cryptographically controlled security groups, time synchronization, network and service pairing, and software updates.

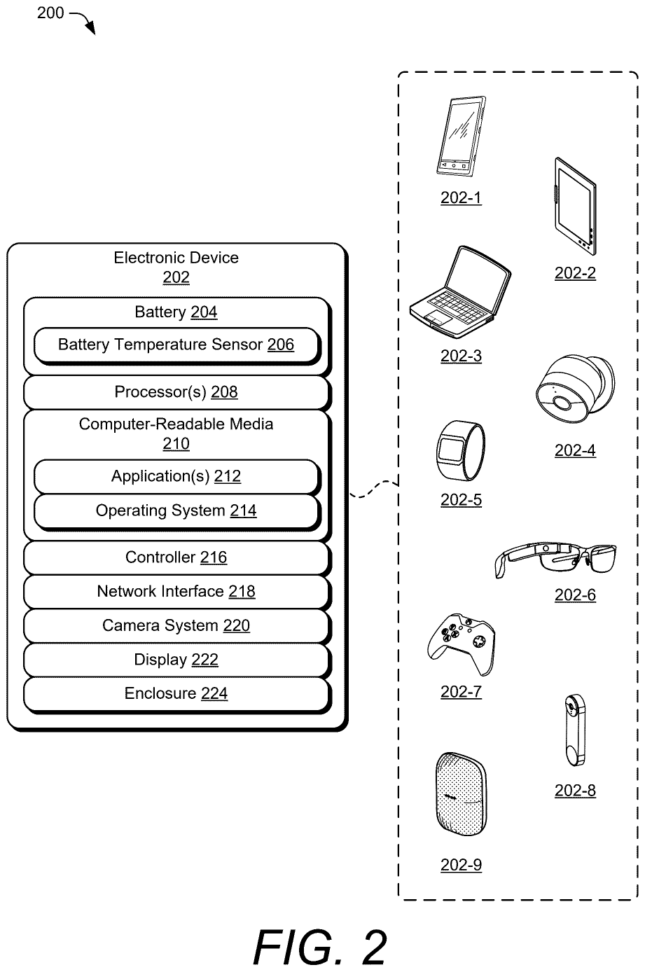

FIG. 2 illustrates an example implementation 200 of an electronic device 202 from FIG. 1 in more detail. The electronic device 202 (e.g., the wireless network device 102, mobile device) of FIG. 2 is illustrated with a variety of example devices, including a smartphone 202-1, a tablet 202-2, a laptop 202-3, a security camera 202-4, a computing watch 202-5, computing spectacles 202-6, a gaming system 202-7, a video-recording doorbell 202-8, and a speaker 202-9. The electronic device 202 can also include other devices, e.g., televisions, entertainment systems, desktop computers, audio systems, projectors, automobiles, drones, track pads, drawing pads, netbooks, e-readers, home security systems, camera systems, thermostats, and other home appliances. Note that the electronic device 202 can be mobile, wearable, non-wearable but mobile, or relatively immobile (e.g., desktops and appliances).

The electronic device 202 includes a battery pack (e.g., battery 204). The battery 204 may be any suitable rechargeable battery. As described herein, the battery 204 may be a Li-ion battery. Various different Li-ion-battery chemistries may be implemented, some examples of which include lithium cobalt oxide (LiCoO2), lithium iron phosphate (LiFePO4), lithium manganese oxide (LiMn2O4 spinel, or Li2MnO3-based lithium-rich layered materials, LMR-NMC), and lithium nickel manganese cobalt oxide (LiNiMnCoO2, Li-NMC, LNMC, NMC, or NCM and the various ranges of Co stoichiometry). Also, Li-ion batteries may include various anode materials, including graphite-based anodes, silicon (Si), graphene, and other cation intercalation/insertion/alloying anode materials. The battery 204 includes a battery connector for physically and electrically coupling to the electronic device 202 to enable power to transfer from the battery 204 to the electronic device 202.

The electronic device 202 also includes a battery temperature sensor 206 (e.g., a battery-side negative thermal coefficient (NTC), a system-level NTC, thermistor) that can measure and/or detect a temperature of the battery. The battery temperature sensor 206 may be internal to the battery 204 and detect the battery temperature inside the battery 204. In another example, the battery temperature sensor 206 may be external to the battery 204 and detect the battery temperature exterior to the battery 204, which may still provide a good indication of the actual temperature of the battery 204.

The electronic device 202 includes one or more processors 208 (e.g., any of microprocessors, microcontrollers, or other controllers) that can process various computer-executable instructions to control the operation of the electronic device 202 and to enable techniques for temperature-based battery-charging-profile architectures and applications thereof. The processors 208 are described in further detail below.

The electronic device 202 also includes computer-readable media 210 (CRM 210) that provides storage for various applications 212 and system data. Applications 212 and/or an operating system 214 implemented as computer-readable instructions on the computer-readable media 210 (e.g., the storage media) can be executed by the processor(s) 208 to provide some or all of the functionalities described herein. The computer-readable media 210 provides data storage mechanisms to store various device applications 212, an operating system 214, memory/storage, and other types of information and/or data related to operational aspects of the electronic device 202. For example, the operating system 214 can be maintained as a computer application within the computer-readable media 210 and executed by the processor(s) 208 to provide some or all the functionalities described herein. The device applications 212 may include a device manager, such as any form of a control application, software application, or signal-processing and control modules. The electronic device 202 may also include, or have access to, one or more machine learning systems.

Various implementations of the application(s) 212 can include, or communicate with, a System-on-Chip (SoC), one or more Integrated Circuits (ICs), a processor with embedded processor instructions or configured to access processor instructions stored in memory, hardware with embedded firmware, a printed circuit board (PCB) with various hardware components, or any combination thereof. The PCB may be formed, for example, from glass-reinforced epoxy material such as FR4. In some instances, the PCB may include a single layer of electrically conductive traces and be a single-layer board. In other instances, the PCB may be a multi-layer board that includes multiple layers of electrically conductive traces that are separated by layers of a dielectric material.

The electronic device 202 may also include a controller 216. The controller 216 may be any suitable controller (e.g., microcontroller, system central processing unit (CPU)) configured to control a switching circuit connected to the battery 204 for switching charge profiles that are used to charge the battery 204. In the techniques described herein, the controller 216 controls the switching circuit based on the temperature of the battery 204 as detected by the battery temperature sensor 206.

The electronic device 202 may also include a network interface 218. The electronic device 202 can use the network interface 218 for communicating data over wired, wireless, optical, or audio (e.g., acoustic) networks. By way of example and not limitation, the network interface 218 may communicate data over a local-area-network (LAN), a wireless local-area-network (WLAN), a home area network (HAN), a personal-area-network (PAN), a wide-area-network (WAN), an intranet, the Internet, a peer-to-peer network, point-to-point network, or a mesh network. The network interface 218 can be implemented as one or more of a serial and/or parallel interface, a wireless interface, any type of network interface, a modem, or any other type of communication interface. Using the network interface 218, the electronic device 202 may communicate via a cloud computing service (e.g., the cloud service 112) to access a platform having resources.

The electronic device 202 also includes a camera system 220. The camera system 220 is configured to capture images, video, and/or audio. Any suitable camera system 220 may be implemented in or communicatively coupled to the electronic device 202. The camera system 220 may be a digital camera that converts light captured by a lens to digital data representing a scene within the field of view of the lens.

The electronic device 202 can also include a display 222 (e.g., display device 222). The display 222 can include any suitable touch-sensitive display device, e.g., a touchscreen, a liquid crystal display (LCD), thin-film transistor (TFT) LCD, an in-place switching (IPS) LCD, a capacitive touchscreen display, an organic light-emitting diode (OLED) display, an active-matrix organic light-emitting diode (AMOLED) display, super AMOLED display, and so forth. The display 222 may be referred to as a display or a screen, such that digital content may be displayed on-screen.

The electronic device 202 also includes an enclosure 224 (e.g., housing). The enclosure 224 houses the various components of the electronic device 202, including, for example, the battery 204 and the camera system 220. In aspects, the enclosure 224 includes at least two portions that are coupled together. The at least two portions of the enclosure 224 can be tightly fitted together with seals to prevent dust and water ingress into the circuitry and other components housed within the enclosure 224.

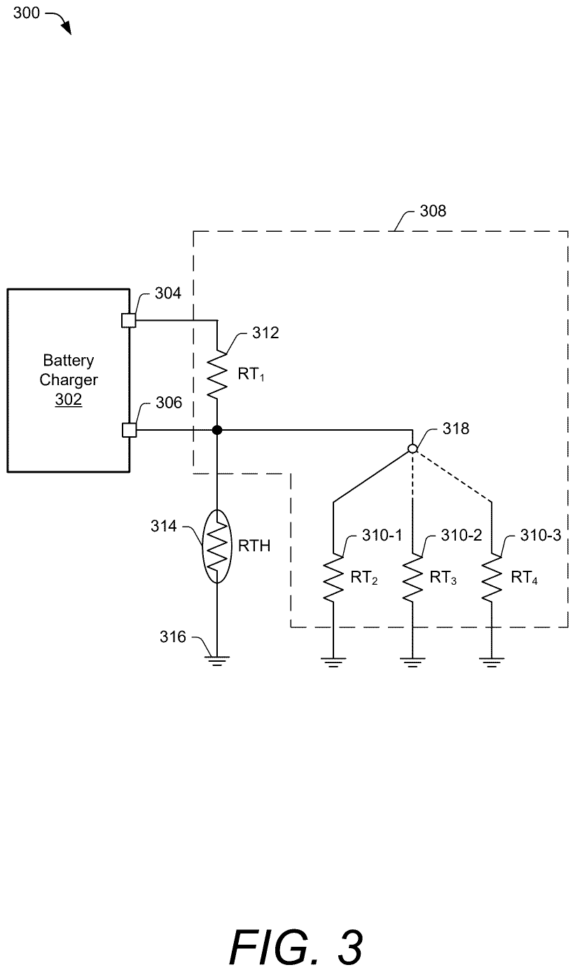

These and other capabilities and configurations, as well as ways in which entities of FIGS. 1 and 2 act and interact, are set forth in greater detail below. These entities may be further divided, combined, and so on. The network environment 100 of FIG. 1 and the detailed illustrations of FIG. 2 through FIG. 9 illustrate some of many possible environments, devices, and methods capable of employing the described techniques, whether individually or in combination with one another. FIGS. 3 to 9 illustrate various implementations of temperature-based battery-charging-profile architectures and applications thereof and are not necessarily limited to the combinations shown for implementing the described techniques. These implementations may be further divided, combined, reorganized, or linked to provide a wide array of additional and/or alternate implementations.

FIG. 3 illustrates an example circuit diagram 300 for implementing temperature-based battery-charging-profile architectures and applications thereof. For example, a battery charger 302 includes first and second terminals 304 and 306, respectively. The battery charger 302 is connected to a voltage-divider network 308.

In some implementations, the voltage-divider network 308 is a resistor-based voltage divider that accommodates a plurality of charge profiles corresponding to a plurality of temperature zones. In the illustrated example, the voltage-divider network 308 includes different sets of resistors 310 (e.g., 310-1, 310-2, and/or 310-3). Each set of resistors 310 has a different charge profile corresponding to a different temperature zone (e.g., range of temperatures). In aspects, the different temperature zones are non-overlapping such that a particular temperature corresponds to a single temperature zone. Accordingly, the battery temperature (or the ambient temperature) can be used to select and apply a particular charge profile.

The voltage-divider network 308 also includes RT1 (e.g., resistor 312). In aspects, RT1 (e.g., resistor 312) is a bias resistor. Also, RT2 (e.g., resistor 310-1) is a negative thermal coefficient (NTC) resistor, which changes resistance versus temperature. RT3 (e.g., resistor 310-2) and RT4 (e.g., resistor 310-3) are also NTC resistors but have different resistor values relative to RT2 and each other. RTH (e.g., resistor 314) is a temperature sensor (e.g., thermistor), which may be a variable resistor that changes over temperature. RTH (resistor 314) is connected to ground 316, as are resistors 310. The different sets of resistors 310 may have the same NTC. However, a controller switches between the different sets of resistors 310 based on temperature (in particular, the battery temperature). Accordingly, a switching mechanism 318 (e.g., multiplexer (MUX)), controlled by the controller, is used to switch between the different sets of resistors 310. In this way, the controller controls the multiplexer to switch between charge profiles.

The battery charger 302 biases the voltage-divider network 308 and reads (e.g., detects or measures) a voltage. Generally, a system temperature is measured by a controller (e.g., microprocessor, system CPU), which may control the switching mechanism. In the illustrated example, the battery charger 302 is concerned with the temperature of the battery and cannot “see” the system. Consequently, the system temperature is monitored by a system CPU or a microprocessor, which controls the switching mechanism. Switching between the different sets of resistors 310 affects the voltage that is read by the battery charger 302. For example, a first set of resistors (e.g., the set of resistors 310-1) may correspond to a temperature scale that is different than a temperature scale corresponding to a second set of resistors (e.g., the set of resistors 310-2). Effectively, the system-side controller controls the switching mechanism 318 to switch to a particular set of resistors 310, and the battery charger 302 relies on the settings of the particular set of resistors 310. In this way, a legacy battery charger may be used with the techniques described herein because it is not necessary for the battery charger to detect or read the system temperature. Accordingly, a low-cost solution can be implemented using a simple general-purpose input/output (GPIO) control from the system CPU to operate the switching mechanism.

In some implementations, at least one of the charge profiles may be associated with a timer, which defines a duration of time for charging the battery 204 at the defined charge rate and corresponding voltage and/or current. For example, some batteries may enable charging at certain temperatures for only a limited amount of time to avoid causing damage to the battery. Accordingly, the timer may enable charging the battery 204 at a particular temperature according to the charge profile for a finite duration of time (e.g., 10 minutes). The controller 216 may cause the charging to cease for another duration of time (e.g., 5 minutes) and then resume the charging for another 10 minutes before stopping the charging again. Accordingly, depending on the limits of the battery chemistry, the controller 216 may cycle-charge the battery according to a particular charge profile when the battery temperature is outside of the limits of the charging standards (e.g., the JEITA mask temperature limits).

In some implementations, the battery charger 302 may include an analog-to-digital converter (ADC) to convert an analog signal (e.g., voltage) to a digital form to be read and processed by the controller. Further, the battery charger 302 may include a system-level NTC and a battery-NTC input.

### Example Methods

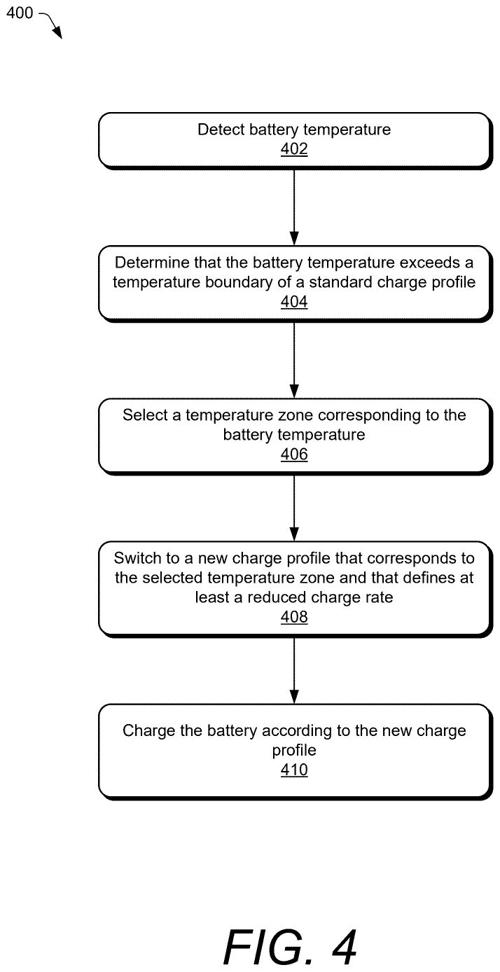

FIGS. 4, 5, and 6 depict example methods 400, 500, and 600, respectively, for temperature-based battery-charging-profile architectures and applications thereof. The methods 400, 500, and 600 can be performed by the electronic device 202 and/or the wireless network device 102. The methods 400, 500, and 600 are shown as a set of blocks that specify operations performed but are not necessarily limited to the order or combinations shown for performing the operations by the respective blocks. Further, any of one or more of the operations may be repeated, combined, reorganized, or linked to provide a wide array of additional and/or alternate methods. In portions of the following discussion, reference may be made to the example network environment 100 of FIG. 1 or to entities or processes as detailed in FIGS. 2-9, reference to which is made for example only. The techniques are not limited to performance by one entity or multiple entities operating on one device.

FIG. 4 depicts a method 400 for applying temperature-based battery-charging profiles in an electronic device. The method 400 may be implemented by the controller 216 of the electronic device 202. In aspects, the controller 216 may use the switching mechanism 318 connected to the voltage-divider network 308 and the battery charger 302 to switch between different charge profiles to charge the battery 204 at different charge rates, voltages, and/or currents based on the battery temperature without violating charging standards for the battery 204.

At 402, a battery temperature is detected. In an example, a system-side controller (e.g., microcontroller, system CPU, controller 216) uses a temperature sensor (e.g., thermistor) to determine a temperature of the battery 204. The temperature sensor may detect the battery temperature. The battery temperature can be detected in regular time intervals or can be detected in response to a trigger condition, e.g., a signal received at the electronic device. In another example in which the battery charger 302 is a closed system with the battery 204, the battery charger 302 may use a temperature sensor to detect the battery temperature.

At 404, the battery temperature is determined, for example by the controller, to exceed a temperature boundary defined by a standard charge profile. For example, the controller 216 may determine that the battery temperature is less than a low-temperature boundary or lower limit defined by a standard charge profile (e.g., JEITA profile) for the battery 204. In many implementations, the JEITA profile defines zero degrees Celsius as the lower limit for safely charging certain Li-ion batteries. In another example, the controller 216 may determine that the battery temperature is greater than a high-temperature boundary or upper limit defined by the standard charge profile (e.g., JEITA profile). In some implementations, the JEITA profile defines the upper limit for safely charging certain Li-ion batteries as 60 °C

At 406, a temperature zone corresponding to the battery temperature is selected. In aspects, the controller 216 identifies which of a plurality of non-overlapping temperature zones corresponds to the battery temperature and selects that zone. In an example, the plurality of temperature zones relate to different temperature ranges. If the detected battery temperature falls within one of the different temperature ranges, then the corresponding temperature zone can be determined and selected. For example, if the battery temperature is −4 °C, the controller 216 may identify and select a temperature zone that is defined as a range from 0 °C to −10 °C. In another example, if the battery temperature is −12 °C, the controller 216 may identify and select a temperature zone that is defined as a range from −10 °C to −20 °C. In another example, if the temperature is 63 °C, the controller 216 may identify and select a temperature zone that is defined as a range of 60 °C to 65 °C

At 408, the controller switches to a new charge profile that corresponds to the selected temperature zone and that defines at least a reduced charge rate. In an example, the controller 216 causes a switching circuit (e.g., switching mechanism 318) connected to a voltage divider network (e.g., the voltage-divider network 308) to switch to a different set of resistors (e.g., resistors 310-1, resistors 310-2, resistors 310-3), which define the new charge profile corresponding to the selected temperature zone. In some implementations, the new charge profile is a low-temperature charge profile (e.g., for a temperature zone that is less than the lower limit of the standard charge profile) defining a specific charge rate at the reduced voltage relative to the standard charge profile for trickle charging the battery at the specific charge rate. The low-temperature charge profile corresponds to a low-temperature scale that is different (e.g., lower) than a temperature scale corresponding to the standard charge profile. In some implementations, the new charge profile is a high-temperature charge profile (e.g., for a temperature zone that is greater than the upper limit of the standard charge profile). The high-temperature charge profile corresponds to a high-temperature scale that is different (e.g., higher) than the temperature scale corresponding to the standard charge profile. In this way, the multiplexer is controllable by the controller 216 to switch between at least the standard charge profile and the new charge profile.

At 410, the battery is charged according to the new charge profile. For example, the battery charger 302 charges the battery 204 according to the set of resistors 310 selected by the controller 216. Also, causing the battery to be charged can comprise notifying the battery charger to charge the battery.

The method 400 may be repeated at any time. To prevent the controller from switching charge profiles back and forth too quickly, hysteresis can be applied. In one example, temperature settings for the charge profiles may have a margin of error implemented. The margin around the temperature setting may be any suitable value (e.g., 1 °C, 1.5 °C, 2 °C). Accordingly, if the battery temperature is fluctuating around the temperature setting, the controller waits for the temperature to rise or drop past the margin before switching to another charge profile.

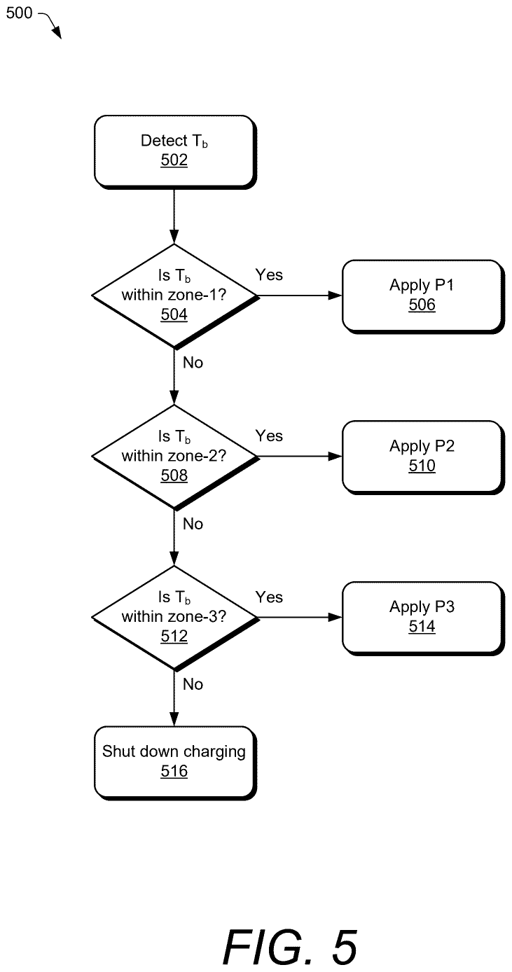

FIG. 5 depicts a method 500 for applying temperature-based battery-charging profiles in an electronic device for high and low temperatures. The method 500 may be implemented by the controller 216 of the electronic device 202. In aspects, the controller 216 may use the switching mechanism 318 connected to the voltage-divider network 308 and the battery charger 302 to switch between different charge profiles to charge the battery 204 at different charge rates, voltages, and/or currents based on the battery temperature without violating charging standards for the battery 204.

At 502, a battery temperature Tb of a battery in an electronic device is detected. The battery temperature Tb may be measured inside the battery 204 or outside the battery 204.

At 504, the controller determines if the battery temperature T_{b} is within a first temperature zone (zone-1), which is defined as a range of temperatures between an upper-temperature boundary and a lower-temperature boundary. For example, the first temperature zone (zone-1) may be a temperature range defined by JEITA (e.g., 0 °C to 60 °C). If the battery temperature is within the range of the first temperature zone (“YES” at 504), then at 506, the system applies a first charge profile P1 for charging the battery 204.

If the battery temperature is not within the range of the first temperature zone (“NO” at 504), then at 506, the controller 216 determines if the battery temperature Tb is within a second temperature zone (zone-2). The second temperature zone is a temperature range that is different than the range of the first temperature zone. In an example, the second temperature zone has a temperature range that is less than (e.g., lower than) the temperature range of the first temperature zone. For example, the second temperature zone may have a range of less than 0 °C (e.g., 0 °C to −10 °C). Accordingly, the temperature range of the second temperature zone does not overlap the temperature range of the first temperature zone. In this example, the second temperature zone can be considered as a low-temperature zone.

If the battery temperature Tb is within the range of the second temperature zone (“YES” at 508), then at 510, the controller 216 applies a second charge profile P2 for charging the battery 204. The second charge profile P2 defines a lower charge rate at a lower voltage and/or a lower current than the first charge profile P1. In aspects, the controller 216 causes a switching mechanism to switch to the second charge profile, which may be defined by a set of resistors that is different than the set of resistors defining the first charge profile P1. In this way, a different charge profile may be applied to charge the battery 204 at low temperatures (e.g., battery temperatures below the lower-temperature boundary of the first temperature zone), if the battery chemistry is capable of charging at such low temperatures.

If the battery temperature Tb is not within the range of the second temperature (“NO” at 508), then at 512, the controller 216 determines if the battery temperature T_{b} is within a third temperature zone (zone-3). The third temperature zone is a temperature range different than those of the first and second temperature ranges. In an example, the third temperature zone (or a fourth temperature zone) has a temperature range that is greater than (e.g., higher than) the temperature range of the first temperature zone and therefore may be considered a high-temperature zone. In this way, a different charge profile may be applied to charge the battery 204 at high temperatures (e.g., battery temperatures greater than the upper-temperature boundary of the first temperature zone), if the battery chemistry is capable of charging at such high temperatures.

If the battery temperature Tb is within the range of the third temperature (“YES” at 512), then at 514, the controller 216 applies a third charge profile P3 for charging the battery 204. The third charge profile P3 defines a lower charge rate at a lower voltage and/or a lower current than the first charge profile P1.

If the battery temperature Tt is not within the range of the third temperature (“NO” at 512), then at 516, charging may be shut down. Although the method 500 is illustrated with three temperature zones, any suitable number (e.g., 2, 3, 4, 5, 6) of temperature zones and corresponding charge profiles may be implemented to charge the battery 204 at different charge rates, voltages, and/or currents based on the temperature of the battery 204.

Similar to the example described with respect to the method 400, hysteresis can be implemented when applying the method 500 to prevent the controller from switching back and forth between charge profiles when the battery temperature fluctuations around a temperature setting (e.g., temperature boundary of a temperature zone).

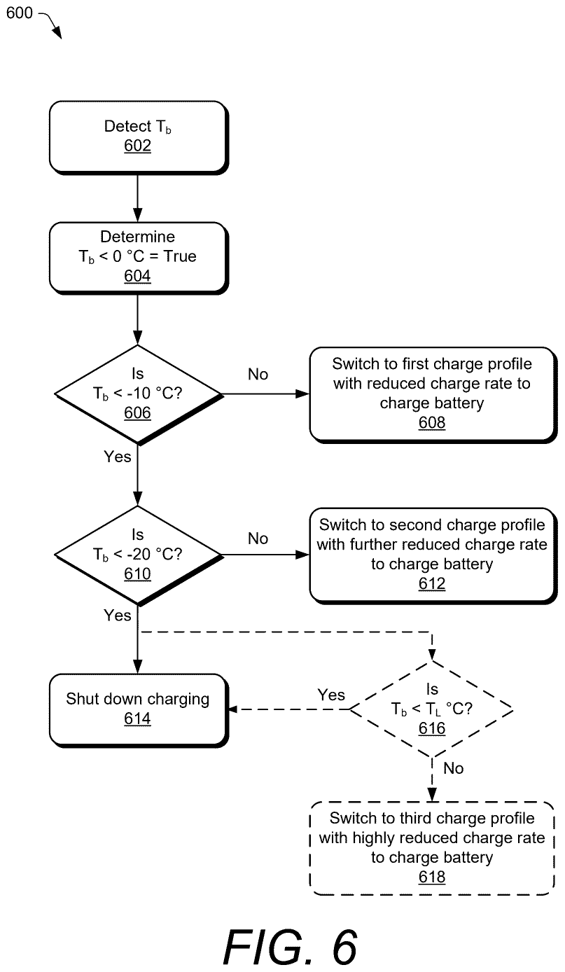

FIG. 6 depicts another example method 600 for applying temperature-based battery-charging profiles in an electronic device for low temperatures. The method 600 may be performed by the controller 216 of the electronic device 202. In aspects, the controller 216 may use the switching mechanism 318 connected to the voltage-divider network 308 and the battery charger 302 to switch between different charge profiles to charge the battery 204 at different charge rates, voltages, and/or currents based on the battery temperature without violating charging standards for the battery 204.

At 602, the battery temperature is detected. The battery temperature T_{b} may be measured inside the battery 204 or outside the battery 204.

At 604, the controller 216 determines that the battery temperature Tb is less than 0 °C. This determination indicates that the battery temperature Tb is below the acceptable temperature range for charging the battery according to the standard charge profile (e.g., JEITA profile).

At 606, the controller 216 determines if the battery temperature T_{b} is less than −10 °C. If the battery temperature Tb is not less than −10 °C (“NO” at 606), which indicates that the battery temperature is between 0 °C and −10 °C, then at 608, the controller 216 switches to a first charge profile with a reduced charge rate to charge the battery. In some implementations, the first charge profile may also define a reduced voltage and/or a reduced current to use at the reduced charge rate. The reduced charge rate, the reduced voltage, and the reduced current are reduced relative to a charge rate, voltage, and current associated with the standard charge profile.

If the battery temperature Tb is less than −10 °C (“YES” at 606), then at 610, the controller 216 determines if the battery temperature Tb is less than −20 °C. This determination helps identify a particular range of temperatures corresponding to the detected battery temperature T_{b}.

If the battery temperature Tb is not less than −20 °C (“NO” at 610), which indicates that the battery temperature is between −10 °C and −20 °C, then at 612, the controller 216 switches to a second charge profile with a further reduced charge rate, relative to the first charge profile, to charge the battery. The second charge profile may also define a further reduced voltage and/or further reduced current to use at the further reduced charge rate.

If the battery temperature T_{b} is less than −20 °C (“YES” at 608), then at 612, the method proceeds to 614 and charging is shut down. This shut down of battery charging is to prevent charging of the battery 204 at extremely low temperatures in which charging may cause damage to the battery itself.

Optionally, the method 600 may include additional low-temperature thresholds and corresponding charge profiles. For example, if the battery temperature T_{b} is less than −20 °C (“YES” at 608), then the method optionally proceeds to 616. At 616, the controller 216 determines if the battery temperature T_{b} is less than a low-temperature threshold T_{L}, which may be a temperature threshold value less than −20 °C. For example, TL may be set at −25 °C, −30 °C, −35 °C, −40 °C, and so forth. If the battery temperature T_{b} is not less than T_{L} (“NO” at 616), indicating that the battery temperature T_{b} is between −20 °C and TL, then at 618, the controller 216 switches to a third charge profile with a highly reduced charge rate, relative to the first charge profile, to charge the battery. If the battery temperature T_{b} is less than T_{L}, then the method 600 may proceed to 614 where charging is shut down.

Although not illustrated in FIG. 6, additional optional low-temperature thresholds, which are lower than T_{L}, may be implemented along with corresponding low-temperature charge profiles. The number of low-temperature thresholds and corresponding charge profiles depends on, and is limited by, the battery chemistry to avoid damaging (e.g., lithium plating) the battery cell.

### Example Environments and Devices

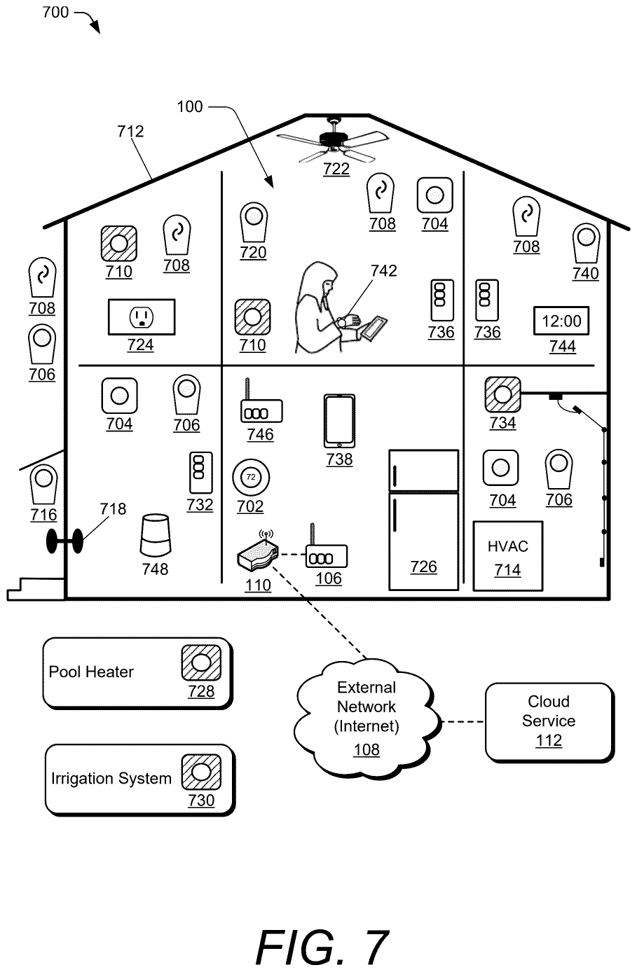

FIG. 7 illustrates an example environment 700 in which a home area network, as described with reference to FIG. 1, and aspects of temperature-based battery-charging-profile architectures and applications thereof can be implemented. Generally, the environment 700 includes the home area network (HAN) implemented as part of a home or other type of structure with any number of wireless network devices 102 (e.g., electronic device 202 or other target device) that are configured for communication in a wireless network. For example, the electronic devices can include a thermostat 702, hazard detectors 704 (e.g., for smoke and/or carbon monoxide), cameras 706 (e.g., indoor and outdoor), lighting units 708 (e.g., indoor and outdoor), and any other types of electronic devices 710 that are implemented inside and/or outside of a structure 712 (e.g., in a home environment). In this example, the electronic devices can also include any of the previously described devices, such as a border router 106, as well as the electronic device 202.

In the environment 700, any number of the electronic devices can be implemented for wireless interconnection to wirelessly communicate and interact with each other. The electronic devices are modular, intelligent, multi-sensing, network-connected devices that can integrate seamlessly with each other and/or with a central server or a cloud-computing system to provide any of a variety of useful automation objectives and implementations. An example of a electronic device that can be implemented as any of the devices described herein is shown and described with reference to FIG. 7.

In implementations, the thermostat 702 may include a Nest® Learning Thermostat that detects ambient climate characteristics (e.g., temperature and/or humidity) and controls an HVAC system 714 in the home environment. The learning thermostat 702 and other network-connected devices “learn” by capturing occupant settings to the devices. For example, the thermostat learns preferred temperature set points for mornings and evenings and when the occupants of the structure are asleep or awake, as well as when the occupants are typically away or at home.

A hazard detector 704 can be implemented to detect the presence of a hazardous substance or a substance indicative of a hazardous substance (e.g., smoke, fire, or carbon monoxide). In examples of wireless interconnection, a hazard detector 704 may detect the presence of smoke, indicating a fire in the structure, in which case the hazard detector that first detects the smoke can broadcast a low-power wake-up signal to all of the connected electronic devices. The other hazard detectors 704 can then receive the broadcast wake-up signal and initiate a high-power state for hazard detection and to receive wireless communications of alert messages. Further, the lighting units 708 can receive the broadcast wake-up signal and activate in the region of the detected hazard to illuminate and identify the problem area. In another example, the lighting units 708 may activate in one illumination color to indicate a problem area or region in the structure, such as for a detected fire or break-in, and activate in a different illumination color to indicate safe regions and/or escape routes out of the structure.

In various configurations, the electronic devices 710 can include an entryway interface device 716 that functions in coordination with a network-connected door lock system 718, and that detects and responds to a person's approach to or departure from a location, such as an outer door of the structure 712. The entryway interface device 716 can interact with the other electronic devices based on whether someone has approached or entered the smart-home environment. An entryway interface device 716 can control doorbell functionality, announce the approach or departure of a person via audio or visual means, and control settings on a security system, such as to activate or deactivate the security system when occupants come and go. The electronic devices 710 can also include other sensors and detectors, such as to detect ambient lighting conditions, detect room-occupancy states (e.g., with an occupancy sensor 720), and control a power and/or dim state of one or more lights. In some instances, the sensors and/or detectors may also control a power state or speed of a fan, such as a ceiling fan 722. Further, the sensors and/or detectors may detect occupancy in a room or enclosure and control the supply of power to electrical outlets or devices 724, such as if a room or the structure is unoccupied.

The electronic devices 710 may also include connected appliances and/or controlled systems 726, such as refrigerators, stoves and ovens, washers, dryers, air conditioners, pool heaters 728, irrigation systems 730, security systems 732, and so forth, as well as other electronic and computing devices, such as televisions, entertainment systems, computers, intercom systems, garage-door openers 734, ceiling fans 722, control panels 736, and the like. When plugged in, an appliance, device, or system can announce itself to the home area network as described above and can be automatically integrated with the controls and devices of the home area network, such as in the home. It should be noted that the electronic devices 710 may include devices physically located outside of the structure but within wireless communication range, such as a device controlling a swimming pool heater 728 or an irrigation system 730.

As described above, the HAN includes a border router 106 that interfaces for communication with an external network, outside the HAN. The border router 106 connects to an access point 110, which connects to the external network 108, such as the Internet. A cloud service 112, which is connected via the external network 108, provides services related to and/or using the devices within the HAN. By way of example, the cloud service 112 can include applications for connecting end-user devices 738, such as smartphones, tablets, and the like, to devices in the home area network, processing and presenting data acquired in the HAN to end-users, linking devices in one or more HANs to user accounts of the cloud service 112, provisioning and updating devices in the HAN, and so forth. For example, a user can control the thermostat 702 and other electronic devices in the home environment using a network-connected computer or portable device, such as a mobile phone or tablet device. Further, the electronic devices can communicate information to any central server or cloud-computing system via the border router 106 and the access point 110. The data communications can be carried out using any of a variety of custom or standard wireless protocols (e.g., Wi-Fi, ZigBee for low power, 6LoWPAN, Thread, etc.) and/or by using any of a variety of custom or standard wired protocols (Category 6 cable (CAT6) Ethernet, HomePlug, and so on).

Any of the electronic devices in the HAN can serve as low-power and communication nodes to create the HAN in the home environment. Individual low-power nodes of the network can regularly send out messages regarding what they are sensing, and the other low-powered nodes in the environment-in addition to sending out their own messages-can repeat the messages, thereby communicating the messages from node to node (e.g., from device to device) throughout the home area network. The electronic devices can be implemented to conserve power, particularly when battery-powered, utilizing low-powered communication protocols to receive the messages, translate the messages to other communication protocols, and send the translated messages to other nodes and/or to a central server or cloud-computing system. For example, the occupancy sensor 720 and/or an ambient light sensor 740 can detect an occupant in a room as well as measure the ambient light, and activate the light source when the ambient light sensor 740 detects that the room is dark and when the occupancy sensor 720 detects that someone is in the room. Further, the sensor can include a low-power wireless communication chip (e.g., an IEEE 802.15.4 chip, a Thread chip, a ZigBee chip) that regularly sends out messages regarding the occupancy of the room and the amount of light in the room, including instantaneous messages coincident with the occupancy sensor detecting the presence of a person in the room. As mentioned above, these messages may be sent wirelessly, using the home area network, from node to node (e.g., network-connected device to network-connected device) within the home environment as well as over the Internet to a central server or cloud-computing system.

In other configurations, various ones of the electronic devices can function as “tripwires” for an alarm system in the home environment. For example, in the event a perpetrator circumvents detection by alarm sensors located at windows, doors, and other entry points of the structure or environment, the alarm could still be triggered by receiving an occupancy, motion, heat, sound, etc. message from one or more of the low-powered mesh nodes in the home area network. In other implementations, the home area network can be used to automatically turn on and off the lighting units 708 as a person transitions from room to room in the structure. For example, the electronic devices can detect the person's movement through the structure and communicate corresponding messages via the nodes of the home area network. Using the messages that indicate which rooms are occupied, other electronic devices that receive the messages can activate and/or deactivate accordingly. As referred to above, the home area network can also be utilized to provide exit lighting in the event of an emergency, such as by turning on the appropriate lighting units 708 that lead to a safe exit. The lighting units 708 may also be turned on to indicate the direction along an exit route that a person should travel to safely exit the structure.

The various electronic devices may also be implemented to integrate and communicate with wearable computing devices 742, such as may be used to identify and locate an occupant of the structure and adjust the temperature, lighting, sound system, and the like accordingly. In other implementations, radio-frequency identification (RFID) sensing (e.g., a person having an RFID bracelet, necklace, or key fob), synthetic vision techniques (e.g., video cameras and face recognition processors), audio techniques (e.g., voice, sound pattern, vibration pattern recognition), ultrasound sensing/imaging techniques, and infrared (IR) or near-field communication (NFC) techniques (e.g., a person wearing an infrared or NFC-capable smartphone), along with rules-based inference engines or artificial intelligence techniques may draw useful conclusions from the sensed information as to the location of an occupant in the structure or environment.

In other implementations, personal comfort-area networks, personal health-area networks, personal safety-area networks, and/or other such human-facing functionalities of service robots can be enhanced by logical integration with other electronic devices and sensors in the environment according to rules-based inferencing techniques or artificial intelligence techniques for achieving better performance of these functionalities. In an example relating to a personal health area, the system can detect whether a household pet is moving toward the current location of an occupant (e.g., using any of the electronic devices and sensors), along with rules-based inferencing and artificial intelligence techniques. Similarly, a hazard detector service robot can be notified that the temperature and humidity levels are rising in a kitchen, and temporarily raise a hazard detection threshold, such as a smoke detection threshold, under an inference that any small increases in ambient smoke levels will most likely be due to cooking activity and not due to a genuinely hazardous condition. Any service robot that is configured for any type of monitoring, detecting, and/or servicing can be implemented as a mesh node device on the home area network, conforming to the wireless interconnection protocols for communicating on the home area network.

The electronic devices 710 may also include a network-connected alarm clock 744 for each of the individual occupants of the structure in the home environment. For example, an occupant can customize and set an alarm device for a wake time, such as for the next day or week. Artificial intelligence can be used to consider occupant responses to the alarms when they go off and make inferences about preferred sleep patterns over time. An individual occupant can then be tracked in the home area network based on a unique signature of the person, which is determined based on data obtained from sensors located in the electronic devices, such as sensors that include ultrasonic sensors, passive IR sensors, and the like. The unique signature of an occupant can be based on a combination of patterns of movement, voice, height, size, etc., as well as using facial or audio recognition techniques.

In an example of wireless interconnection, the wake time for an individual can be associated with the thermostat 702 to control the HVAC system in an efficient manner so as to pre-heat or cool the structure to desired sleeping and awake temperature settings. The preferred settings can be learned over time, such as by capturing the temperatures set in the thermostat before the person goes to sleep and upon waking up. Collected data may also include biometric indications of a person, such as breathing patterns, heart rate, movement, etc., from which inferences are made based on this data in combination with data that indicates when the person actually wakes up. Other electronic devices can use the data to provide other automation objectives, such as adjusting the thermostat 702 to pre-heat or cool the environment to a desired setting and turning on or turning off the lighting units 708.

In implementations, the electronic devices can also be utilized for sound, vibration, and/or motion sensing such as to detect running water and determine inferences about water usage in a home environment based on algorithms and mapping of the water usage and consumption. This can be used to determine a signature or fingerprint of each water source in the home and is also referred to as “audio fingerprinting water usage.” Similarly, the electronic devices can be utilized to detect the subtle sound, vibration, and/or motion of unwanted pests, such as mice and other rodents, as well as termites, cockroaches, and other insects. The system can then notify an occupant of the suspected pests in the environment, such as with warning messages to help facilitate early detection and prevention.

The environment 700 may include one or more electronic devices that function as a hub 746. The hub 746 (e.g., hub 120) may be a general-purpose home automation hub, or an application-specific hub, such as a security hub, an energy management hub, an HVAC hub, and so forth. The functionality of a hub 746 may also be integrated into any electronic device, such as a network-connected thermostat device or the border router 106. Hosting functionality on the hub 746 in the structure 712 can improve reliability when the user's internet connection is unreliable, can reduce latency of operations that would normally have to connect to the cloud service 112, and can satisfy system and regulatory constraints around local access between electronic devices.

Additionally, the example environment 700 includes a network-connected-speaker 748. The network-connected speaker 748 provides voice assistant services that include providing voice control of network-connected devices. The functions of the hub 746 may be hosted in the network-connected speaker 748. The network-connected speaker 748 can be configured to communicate via the HAN, which may include a wireless mesh network, a Wi-Fi network, or both.

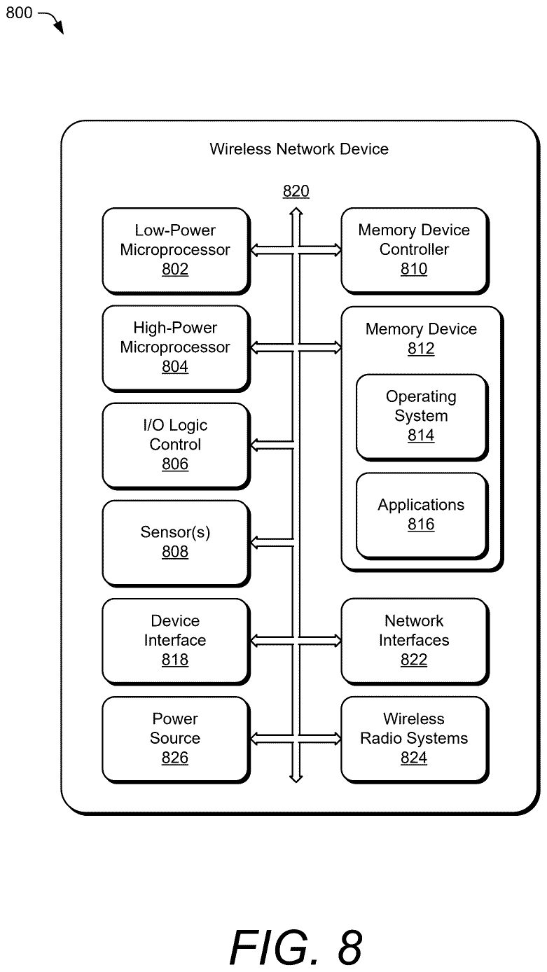

FIG. 8 illustrates an example electronic device 800 that can be implemented as any of the wireless network devices 102 (e.g., electronic device 202 or other target device) in a home area network in accordance with one or more aspects of temperature-based battery-charging-profile architectures and applications thereof as described herein. The device 800 can be integrated with electronic circuitry, microprocessors, memory, input/output (I/O) logic control, communication interfaces and components, as well as other hardware, firmware, and/or software to implement the device in a home area network. Further, the electronic device 800 can be implemented with various components, such as with any number and combination of different components as further described with reference to the example device shown in FIG. 8.

In this example, the electronic device 800 includes a low-power microprocessor 802 and a high-power microprocessor 804 (e.g., microcontrollers or digital signal processors) that process executable instructions. The device also includes an input-output (I/O) logic control 806 (e.g., to include electronic circuitry). The microprocessors can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits. The low-power microprocessor 802 and the high-power microprocessor 804 can also support one or more different device functionalities of the device. For example, the high-power microprocessor 804 may execute computationally intensive operations, whereas the low-power microprocessor 802 may manage less-complex processes such as detecting a hazard or temperature from one or more sensors 808. The low-power microprocessor 802 may also wake or initialize the high-power microprocessor 804 for computationally intensive processes.

The one or more sensors 808 can be implemented to detect various properties such as acceleration, temperature, humidity, water, supplied power, proximity, external motion, device motion, sound signals, ultrasound signals, light signals, fire, smoke, carbon monoxide, global navigation satellite systems (GNSS) signals (e.g., GPS signals), radio frequency (RF), other electromagnetic signals or fields, or the like. As such, the sensors 808 may include any one or a combination of temperature sensors, humidity sensors, hazard-related sensors, other environmental sensors, accelerometers, microphones, optical sensors up to and including cameras (e.g., charged coupled-device or video cameras, active or passive radiation sensors, GPS receivers, and radio frequency identification detectors. In implementations, the electronic device 800 may include one or more primary sensors, as well as one or more secondary sensors, such as primary sensors that sense data central to the core operation of the device (e.g., sensing a temperature in a thermostat or sensing smoke in a smoke detector), while the secondary sensors may sense other types of data (e.g., motion, light or sound), which can be used for energy-efficiency objectives or automation objectives.

The electronic device 800 includes a memory device controller 810 and a memory device 812, such as any type of a nonvolatile memory and/or other suitable electronic data storage device. The electronic device 800 can also include various firmware and/or software, such as an operating system 814 that is maintained as computer-executable instructions by the memory and executed by a microprocessor. The device software may also include one or more applications 816 (e.g., applications 212) that implement various functionalities of the electronic device 800. The electronic device 800 also includes a device interface 818 to interface with another device or peripheral component and includes an integrated data bus 820 that couples the various components of the electronic device for data communication between the components. The data bus in the electronic device may also be implemented as any one or a combination of different bus structures and/or bus architectures.

The device interface 818 may receive input from a user and/or provide information to the user (e.g., as a user interface), and a received input can be used to determine a setting. The device interface 818 may also include mechanical or virtual components that respond to a user input. For example, the user can mechanically move a sliding or rotatable component, or the motion along a touchpad may be detected, and such motions may correspond to a setting adjustment of the device. Physical and virtual movable user-interface components can allow the user to set a setting along a portion of an apparent continuum. The device interface 818 may also receive inputs from any number of peripherals, such as buttons, a keypad, a switch, a microphone, and an imager (e.g., a camera device).

The electronic device 800 can include network interfaces 822 (e.g., network interface 218), such as a home area network interface for communication with other electronic devices in a home area network, and an external network interface for network communication, such as via the Internet. The electronic device 800 also includes wireless radio systems 824 for wireless communication with other electronic devices via the home area network interface and for multiple, different wireless communications systems. The wireless radio systems 824 may include Wi-Fi, Bluetooth™M, Mobile Broadband, Bluetooth Low Energy (BLE), and/or point-to-point IEEE 802.15.4. Each of the different radio systems can include a radio device, antenna, and chipset that is implemented for a particular wireless communications technology. The electronic device 800 also includes a power source 826, such as a battery (e.g., battery 204) and/or a cable to connect the device to line voltage. An alternating current (AC) power source may also be used to charge the battery of the device.

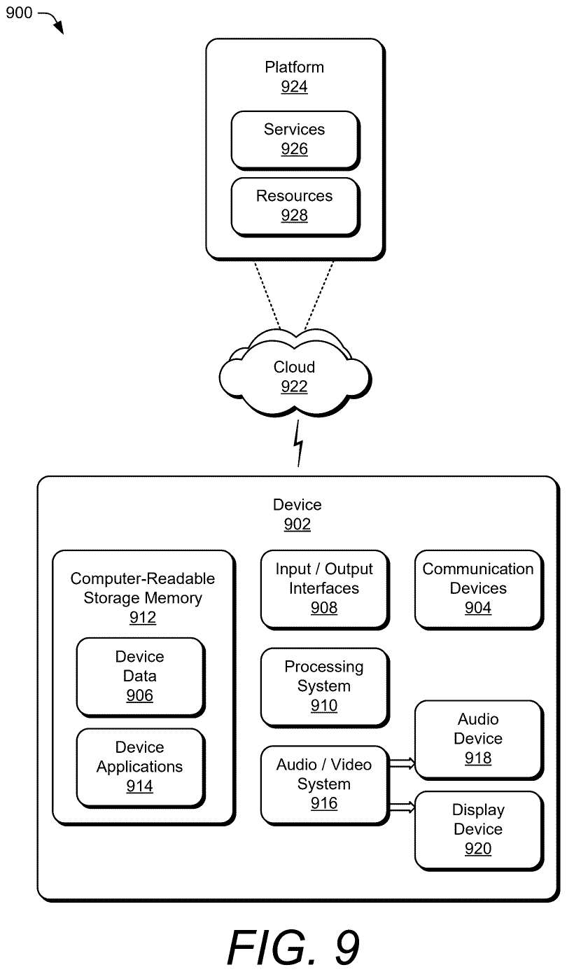

FIG. 9 illustrates an example system 900 that includes an example device 902, which can be implemented as any of the wireless network devices 102 (e.g., electronic device 202 or other target device) that implement aspects of temperature-based battery-charging-profile architectures and applications thereof as described with reference to the previous FIGS. 1 to 8. The example device 902 may be any type of computing device, client device, mobile phone, tablet, communication, entertainment, gaming, media playback, and/or other type of device. Further, the example device 902 may be implemented as any other type of electronic device that is configured for communication on a home area network, such as a thermostat, hazard detector, camera, lighting unit, commissioning device, router, border router, joiner router, joining device, end device, leader, access point, and/or other electronic devices.

The device 902 includes communication devices 904 that enable wired and/or wireless communication of device data 906, such as data that is communicated between the devices in a home area network, data that is being received, data scheduled for broadcast, data packets of the data, data that is synched between the devices, etc. The device data can include any type of communication data, as well as audio, video, and/or image data that is generated by applications executing on the device. The communication devices 904 can also include transceivers for cellular phone communication and/or for network data communication.

The device 902 also includes input/output (I/O) interfaces 908, such as data network interfaces (e.g., network interface 218) that provide connection and/or communication links between the device, data networks (e.g., a home area network, external network, etc.), and other devices. The I/O interfaces can be used to couple the device to any type of components, peripherals, and/or accessory devices. The I/O interfaces also include data input ports via which any type of data, media content, and/or inputs can be received, such as user inputs to the device, as well as any type of communication data, as well as audio, video, and/or image data received from any content and/or data source.

The device 902 includes a processing system 910 (e.g., processors 208) that may be implemented at least partially in hardware, such as with any type of microprocessors, controllers, and the like that process executable instructions. The processing system can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits. The device 902 may further include any type of a system bus or other data and command transfer system that couples the various components within the device. A system bus can include any one or combination of different bus structures and architectures, as well as control and data lines.

The device 902 also includes computer-readable storage memory 912 (e.g., CRM 210), such as data storage devices that can be accessed by a computing device, and that provide persistent storage of data and executable instructions (e.g., software applications, modules, programs, functions, and the like). The computer-readable storage memory described herein excludes propagating signals. Examples of computer-readable storage memory include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, erasable programmable read-only memory (EPROM), electrically erasable programmable read-only memory (EEPROM), and other types of storage memory in various memory device configurations.

The computer-readable storage memory 912 provides storage of the device data 906 and various device applications 914 (e.g., applications 212), such as an operating system (e.g., operating system 214) that is maintained as a software application with the computer-readable storage memory and executed by the processing system 910. The device applications 914 may also include a device manager, such as any form of a control application, software application, signal processing and control module, code that is native to a particular device, a hardware abstraction layer for a particular device, and so on.

The device 902 also includes an audio and/or video system 916 that generates audio data for an audio device 918 and/or generates display data for a display device 920 (e.g., display 222). The audio device and/or the display device include any devices that process, display, and/or otherwise render audio, video, display, and/or image data, such as the image content of a digital photo. In implementations, the audio device and/or the display device are integrated components of the example device 902. Alternatively, the audio device and/or the display device are external, peripheral components to the example device. In aspects, at least part of the techniques described for temperature-based battery-charging-profile architectures and applications thereof may be implemented in a distributed system, such as over a “cloud” 922 in a platform 924. The cloud 922 includes and/or is representative of the platform 924 for services 926 and/or resources 928.

The platform 924 abstracts underlying functionality of hardware, such as server devices (e.g., included in the services 926) and/or software resources (e.g., included as the resources 928), and connects the example device 902 with other devices, servers, etc. The resources 928 may also include applications and/or data that can be utilized while computer processing is executed on servers that are remote from the example device 902. Additionally, the services 926 and/or the resources 928 may facilitate subscriber network services, such as over the Internet, a cellular network, or Wi-Fi network. The platform 924 may also serve to abstract and scale resources to service a demand for the resources 928 that are implemented via the platform, such as in an interconnected device aspect with functionality distributed throughout the system 900. For example, the functionality may be implemented in part at the example device 902 as well as via the platform 924 that abstracts the functionality of the cloud 922.

Some examples are provided below:
Example 1: A method for implementing temperature-based battery-charging-profile architectures and applications, the method comprising: detecting a battery temperature of a battery of an electronic device; determining that the battery temperature exceeds a temperature boundary defined by a standard charge profile; switching to a first charge profile corresponding to the detected temperature, the first charge profile defining a reduced charge rate at a reduced voltage or a reduced current relative to the standard charge profile; and causing the battery to be charged according to the first charge profile.

Example 2: The method of example 1, wherein: the detected temperature corresponds to a low-temperature zone having a temperature range of less than 0 °C; and the first charge profile is a low-temperature charge profile defining a specific charge rate at the reduced voltage relative to the standard charge profile for trickle charging the battery at the specific charge rate.

Example 3: The method of example 2, wherein the detected temperature is between 0 °C and −10 °C

Example 4: The method of any of examples 1 to 3, further comprising selecting, from a plurality of temperature zones, a temperature zone corresponding to the battery temperature, wherein the first charge profile corresponds to the selected temperature zone, and wherein the plurality of temperature zones correspond to a plurality of charge profiles including at least the standard charge profile, the first charge profile, and a second charge profile.

Example 5: The method of example 4, wherein: the plurality of temperature zones includes at least a first low-temperature zone and a second low-temperature zone; the first low-temperature zone is between 0 °C and −10 °C; and the second low-temperature zone is less than −10 °C.

Example 6: The method of example 5, wherein: the first charge profile corresponds to the first low-temperature zone; the second charge profile corresponds to the second low-temperature zone; and the second charge profile defines a further reduced charge rate at a further reduced voltage relative to the first charge profile for trickle charging the battery at the further reduced charge rate.

Example 7: The method of any one of example 5, wherein: the first charge profile corresponds to the second low-temperature zone; the second charge profile corresponds to the first low-temperature zone; the second charge profile defines a second charge rate at a lower voltage relative to the standard charge profile for trickle charging the battery at the second charge rate; and the reduced charge rate defined by the first charge profile is reduced relative to the second charge rate defined by the second charge profile.

Example 8: The method of example 4, wherein: the plurality of temperature zones includes at least a low-temperature zone and a high-temperature zone; the first charge profile corresponds to the low-temperature zone; and the second charge profile corresponds to the high-temperature zone.

Example 9: The method of example 8, wherein: the low-temperature zone corresponds to battery temperatures less than a lower-temperature boundary of the standard charge profile; and the high-temperature zone corresponds to battery temperatures greater than an upper-temperature boundary of the standard charge profile.

Example 10: The method of example 9, wherein the lower-temperature boundary of the standard charge profile is 0 °C

Example 11: The method of example 9 or example 10, wherein the upper-temperature boundary of the standard charge profile is 60 °C

Example 12: The method of any one of the preceding examples, wherein switching to the first charge profile includes operating a switching circuit, connected to a voltage divider network and a multiplexer, to switch from the standard charge profile to the first charge profile.

Example 13: An electronic device for temperature-based battery-charging-profile architectures and applications, the electronic device comprising: a battery for providing power to operate the electronic device; a charger chip for charging the battery using line power; a switching circuit for switching between different charge profiles for charging the battery, the different charge profiles including at least a standard charge profile and a first charge profile; and a controller for controlling the switching circuit based on a battery temperature of the battery to charge the battery according to a particular charge profile by performing the method of any one of examples 1 to 12.

Example 14: The electronic device of example 13, wherein the switching circuit comprises: a resistor-based voltage divider that accommodates a plurality of charge profiles corresponding to a plurality of temperature zones; and a multiplexer controllable by the controller to switch between at least the standard charge profile and the first charge profile.

Example 15: The electronic device of example 13 or example 14, wherein the first charge profile corresponds to a low-temperature scale that is different than a temperature scale corresponding to the standard charge profile.

### Conclusion

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying figures and terms discussed herein may be indicative of one or more items or terms, and thus reference may be made interchangeably to single or plural forms of the items and terms in this written description.

Although aspects of temperature-based battery-charging-profile architectures and applications thereof have been described in language specific to features and/or methods, the subject of the appended claims is not necessarily limited to the specific features or methods described. Rather, the specific features and methods are disclosed as example implementations of the techniques for temperature-based battery-charging-profile architectures and applications thereof, and other equivalent features and methods are intended to be within the scope of the appended claims. Further, various aspects are described, and it is to be appreciated that each described aspect can be implemented independently or in connection with one or more other described aspects.

1. A method for implementing temperature-based battery-charging-profile architectures and applications, the method comprising:
detecting a battery temperature of a battery of an electronic device;
determining that the battery temperature exceeds a temperature boundary defined by a standard charge profile;
selecting, from a plurality of temperature zones defining non-overlapping ranges of temperatures, a temperature zone corresponding to the battery temperature,
switching to a first charge profile corresponding to the selected temperature zone, the first charge profile defining a reduced charge rate at a reduced voltage or a reduced current relative to the standard charge profile; and
causing the battery to be charged according to the first charge profile.

2. The method of claim 1, wherein:
the battery temperature corresponds to a low temperature zone having a temperature range of less than 0 °C; and
the first charge profile is a low-temperature charge profile defining a specific charge rate at the reduced voltage relative to the standard charge profile for trickle charging the battery at the specific charge rate.

3. The method of claim 2, wherein the battery temperature is between 0 °C and —10 C.

4. The method of claim 1, wherein the plurality of temperature zones correspond to a plurality of charge profiles including at least the standard charge profile, the first charge profile, and a second charge profile.

5. The method of claim 4, wherein:
the plurality of temperature zones includes at least a first low-temperature zone and a second low-temperature zone;
the first low-temperature zone is between 0 °C and −10 °C; and
the second low-temperature zone is less than −10 °C.

6. The method of claim 5, wherein:
the first charge profile corresponds to the first low-temperature zone;
the second charge profile corresponds to the second low-temperature zone; and
the second charge profile defines a further reduced charge rate at a further reduced voltage relative to the first charge profile for trickle charging the battery at the further reduced charge rate.

7. The method of claim 5, wherein:
the first charge profile corresponds to the second low-temperature zone;
the second charge profile corresponds to the first low-temperature zone;
the second charge profile defines a second charge rate at a lower voltage relative to the standard charge profile for trickle charging the battery at the second charge rate; and
the reduced charge rate defined by the first charge profile is reduced relative to the second charge rate defined by the second charge profile.

8. The method of claim 4, wherein:
the plurality of temperature zones includes at least a low-temperature zone and a high-temperature zone;
the first charge profile corresponds to the low-temperature zone; and
the second charge profile corresponds to the high-temperature zone.

9. The method of claim 8, wherein:
the low-temperature zone corresponds to battery temperatures less than a lower-temperature boundary of the standard charge profile; and
the high-temperature zone corresponds to battery temperatures greater than an upper-temperature boundary of the standard charge profile.

10. The method of claim 9, wherein the lower-temperature boundary of the standard charge profile is 0 °C.

11. The method of claim 9, wherein the upper-temperature boundary of the standard charge profile is 60 °C.

12. The method of claim 1 claims, wherein switching to the first charge profile includes operating a switching circuit, connected to a voltage divider network and a multiplexer, to switch from the standard charge profile to the first charge profile.

13. An electronic device for temperature-based battery-charging-profile architectures and applications, the electronic device comprising:
a battery for providing power to operate the electronic device;
a charger chip for charging the battery using line power;
a switching circuit for switching between different charge profiles for charging the battery, the different charge profiles including at least a standard charge profile and a first charge profile; and
a controller for controlling the switching circuit based on a battery temperature of the battery to charge the battery according to a particular charge profile, the controller configured to:
determine the battery temperature of the battery;
determine that the battery temperature exceeds a temperature boundary defined by the standard charge profile;
select, from a plurality of temperature zones defining non-overlapping ranges of temperatures, a temperature zone corresponding to the battery temperature;
cause the switching circuit to switch to the first charge profile, the first charge profile corresponding to the selected temperature zone and defining a reduced charge rate at a reduced voltage or a reduced current relative to the standard charge profile; and
cause the battery to be charged according to the first charge profile.

14. The electronic device of claim 13, wherein the switching circuit comprises:
a resistor-based voltage divider that accommodates a plurality of charge profiles corresponding to a plurality of temperature zones; and
a multiplexer controllable by the controller to switch between at least the standard charge profile and the first charge profile.

15. The electronic device of claim 13 wherein the first charge profile corresponds to a low-temperature scale that is different from a temperature scale corresponding to the standard charge profile.

16. The electronic device of claim 14, wherein:
the switching circuit is connected to the resistor-based voltage divider;
the resistor-based voltage divider includes a plurality of sets of resistors;
each set of resistors of the plurality of sets of resistors define a different charge profile compared to one another; and
each charge profile corresponding to a different temperature zone compared to one another.

17. The electronic device of claim 16, wherein the resistor-based voltage divider includes at least one of a bias resistor and at least one negative thermal coefficient resistor.

18. The electronic device of claim 16, wherein the sets of resistors of the plurality of sets of resistors have a same negative thermal coefficient as one another.

19. The electronic device of claim 16, wherein:
the plurality of sets of resistors includes at least first and second sets of resistors; and
the first set of resistors corresponds to a first temperature scale; and
the second set of resistors corresponds to a second temperature scale that is different from the first temperature scale.

20. The electronic device of claim 13, wherein:
the plurality of temperature zones includes at least a first low-temperature zone and a second low-temperature zone;
the first low-temperature zone is between 0 °C and −10 °C; and
the second low-temperature zone is less than −10 C.
